(19) United States
(12) Patent Application Publication
(10) Pub. No.: US 2004/0006477 A1
(43) Pub. Date: Jan. 8, 2004

(54) Voice-controllable communication gateway for controlling multiple electronic and information appliances

(76) Inventor: Michael L. Craner, Exton, PA (US)

Correspondence Address: VOLPE AND KOENIG, P.C., DEPT. MOT, UNITED PLAZA, SUITE 1600, 30 SOUTH 17TH STREET, PHILADELPHIA, PA, 19103, US

(21) Appl. No.: 10/190,255

(22) Filed: Jul. 5, 2002

(51) Int. Cl. G10L 21/00

(52) U.S. Cl. 704/275

(57) ABSTRACT

A voice-controlled communication gateway for facilitating communications between a plurality of outside entities and at least one electronic device includes a receiver for receiving communications from the outside entities; a transmitter for transmitting communications to the outside entities; a microphone for receiving audible signals within an environment; a voice module for receiving an input from the microphone and for translating the input into a command; a microprocessor coupled to the receiver, transmitter and voice command processing module for receiving and executing the command; and a signal output from each electronic device corresponding to the audible output from the electronic device. The voice command processing module subtracts the signal output from each electronic device from the audible signal to produce the command signal.

### BACKGROUND

The present generally relates to a voice-controllable communication gateway. More particularly, the present invention is directed to a communication gateway which permits control of multiple electronic or information appliances via voice commands from a user.

The control of various in-home electronic devices or information appliances has become more problematic in recent years. On the positive side, as the cost of these devices has dropped, consumers have had access to, and taken advantage of, the myriad of different entertainment choices available to them. For example, the entertainment center of a home may include not only traditional electronic devices such as a television and a VCR, but also a CD player, a DVD player, a personal video recorder and/or a personal computer. Each of these electronic devices is typically associated with an infrared interface which permits control of the device without requiring the user to manually contact control buttons on the device. Although remote control of an electronic device is convenient, requiring a separate remote control for each device results in frustration for users who to fumble with, and attempt to keep track of, which remote control controls which device.

“Universal” remote controls have been developed which permit a user to control many different types of devices from different manufacturers using a single remote control. Although this has provided a first step toward simplifying the control of multiple electronic devices, universal remote controls generally provide a limited range of commands to a limited range of electronic components. For example, most universal remote controls will permit the user to turn a device on and off, and operate the device in accordance with a basic level of functionality, (such as controlling the volume and the channels of a television or controlling the playing of a movie on a VCR or DVD player). By pushing a selected key on a remote control for a designated electronic device, a corresponding command signal is transmitted by an infrared (IR) signal to the designated electronic device to invoke the operation in the intended device. The limited number of predefined function keys on a universal remote control restricts the number of commands a user can issue from a universal remote control. On the other hand, although some universal remote controls include many different buttons for many different functions, a large number of buttons can present a confusing number of choices for a consumer.

Universal remote controls are also not well adapted for newer electronic devices which do not have a predefined set of input commands. For example, use of a personal computer, or web browsing through a settop terminal presents the user with an unlimited number of selections and choices. Current universal remote controls are not well adapted to function in such an environment.

As society has become more reliant on information technology, settop terminals have evolved from devices which provide an interface between the CATV system and the home for delivering video and audio content, to communication gateways which provide broadband access by a home owner to a CATV network, a public switch telephone network (PSTN) or a wireless network. Therefore, communication gateways have become a hub between a home owner's information needs and the plurality of available of outside communication networks.

U.S. Pat. No. 5,138,649 (Krisbergh et al.) discloses a television remote control and telephone hand-set apparatus which permits the transmission of television controls signals via an infrared (IR) communication link and telephone control signals via the IR or a separate radio frequency (RF) communication link. The system includes a microphone for generating telephone audio signals that are transmitted via the RF communication link and an earphone for reproducing telephone audio signals. The earphone receives telephone audio signals via the RF communication link. Although this system simplifies control of the television and permits use of the telephone, it is indicative of those systems in the prior art which are generally limited to control of a predefined set of instructions for particular electronic components.

It would be desirable to provide a communication gateway which permits control of a plurality of information appliances or electronic devices in a simple and user-friendly manner.

### SUMMARY

The communication gateway in accordance with the present invention includes a voice command processor which receives a users' voice commands, interprets the voice commands and converts them into equivalent electronic device specific commands to be carried out by the designated electronic device. The voice command processor receives the audible output from each of one or more information appliances or electronic devices; these audible signals are designated herein as “known” noise sources. The voice command processor also receives an audible input signal from all of the audible sounds within the operating environment, (i.e., a “composite signal”). The inputs from the known noise sources are deleted from the composite signal. The resulting signal will comprise primarily the user's voice command.

### BRIEF DESCRIPTION OF THE DRAWING(S)

FIG. 1 is a block diagram of a communication system in accordance with the present invention including a communication gateway.

FIG. 2 is a functional block diagram of a communication gateway in accordance with the present invention.

FIG. 3 is a block diagram of the voice command processing module.

FIG. 4 is a front view of the communication gateway.

FIG. 5 is a flow diagram of the noise cancellation method in accordance with the present invention.

FIG. 6 is a flow diagram of an alternative method of the present invention.

FIG. 7 is a wireless phone embodying the alternative method of the present invention.

FIG. 8 is a flow diagram of a procedure using the wireless phone of FIG. 7.

### DETAILED DESCRIPTION OF THE PREFERRED EMBODIMENT(S)

The present invention permits voice control of any type of information appliance without requiring the use of a remote control device. The present invention will be described with reference to the drawing figures wherein like numerals represent like elements throughout.

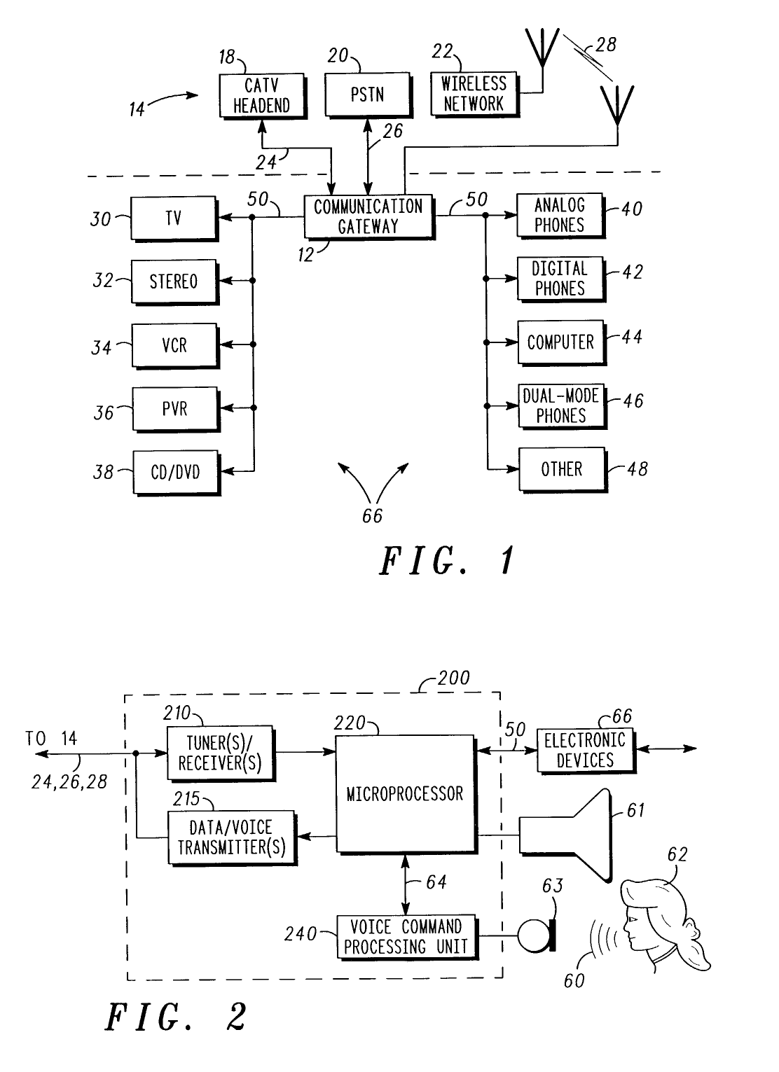

Referring to FIG. 1, a communication system 10 in accordance with the present invention comprises a communication gateway 12 located within a user's home 16. The communication gateway 12 is coupled to outside entities 14 including a CATV headend 18, a PSTN 20 and a wireless network 22. The communication gateway 12 is preferably coupled to the CATV headend 18 via a fiber optic link 24; to the PSTN 20 via a 2 or 4-wire line appearance 26; and to the wireless network 22 via an RF interface 28. It should be recognized by those of skill in the art that the fiberoptic link 24, the line appearance 26 and the RF interface 28 are generally known as the external communication links and may comprise other manifestations of a physical link such as a satellite link, microwave link or coaxial cable. The specific type of external communication link is not important to the present invention.

Inside the home 16, the communication gateway 12 is coupled to a plurality of electronic devices or information appliances (hereinafter “electronic devices 66”) including, but not limited to, a television 30, stereo 32, VCR 34, personal video recorder (PVR) 36, CD-DVD player 38, analog telephones 40, digital telephones 42, personal computer 44 or dual mode phones 46. It should also be noted that “non-information type” electronic devices may be controlled in accordance with the present invention such as a home security system, HVAC system, electrical system or any other type of electrical or electronic component 48 located within, or in the proximity of, a home 16.

It should also be understood that each electronic device 66 will have a power supply (not shown) and an internal communication link 50 with the communication gateway 12. The internal communication link 50 may be a shared bus or may be a dedicated line. Additionally, the communication link 50 may comprise an Ethernet connection, USB connection, RJ 11, a parallel or serial connection or any other type of connection which is appropriate or required by the electronic device.

As will described in detail hereinafter, the communication gateway 12 is able to control any electronic device 66 and control the link between any electronic device 66 and an outside entity 14 via the external communication links 24, 26, 28. The communication gateway 12 permits such control without requiring the use of any type of remote control apparatus; although one embodiment disclosed herein includes such an option.

Referring to FIG. 2, a functional block diagram of a communication gateway 200 (CG) made in accordance with the present invention is shown. The CG 200 includes a frequency agile tuner and/or multiple receivers 210, at least one data/voice transmitter 215, a microprocessor 220, one or more internal communication links 50, one or more external communication links 24, 26, 28, a voice command processing module 240, a frontal display 61 and a microphone 63.

The microprocessor 220 controls all internal functions of the CG 200 including of the processing and routing of video, audio and data content for output via the internal communication link 50 to the proper electronic device 66. The microprocessor 220 also controls the tuner(s)/receiver(s) 210, the data/voice transmitter(s) 215 and the voice command processing module 240. The tuner/receiver 210 receives all incoming information from the external communication links 24, 26, 28. For example, if the information is incoming via the CATV headend 18 over a fiber optic link 24, a frequency agile tuner is included. Likewise, if the incoming signal is received from the wireless network 22 over the wireless link 28, an RF receiver is included. Finally, if the incoming signal originates from the PSTN 20 and is incoming via the 2 or 4-wire line appearance 26, a telephone receiver is included. Accordingly, the type of tuner or receiver will depend upon the interface with the outside entity 14. Further, the CG 200 may include a plurality of each type of tuner/receiver.

The data/voice transmitter 215 comprises one or more transmitters for transmitting information from the CG 200 to the outside entities 14. As with the tuner/receiver 210, the particular type of transmitter will depend upon the type of signal transmitted and the communication link 24, 26, 28 to be used.

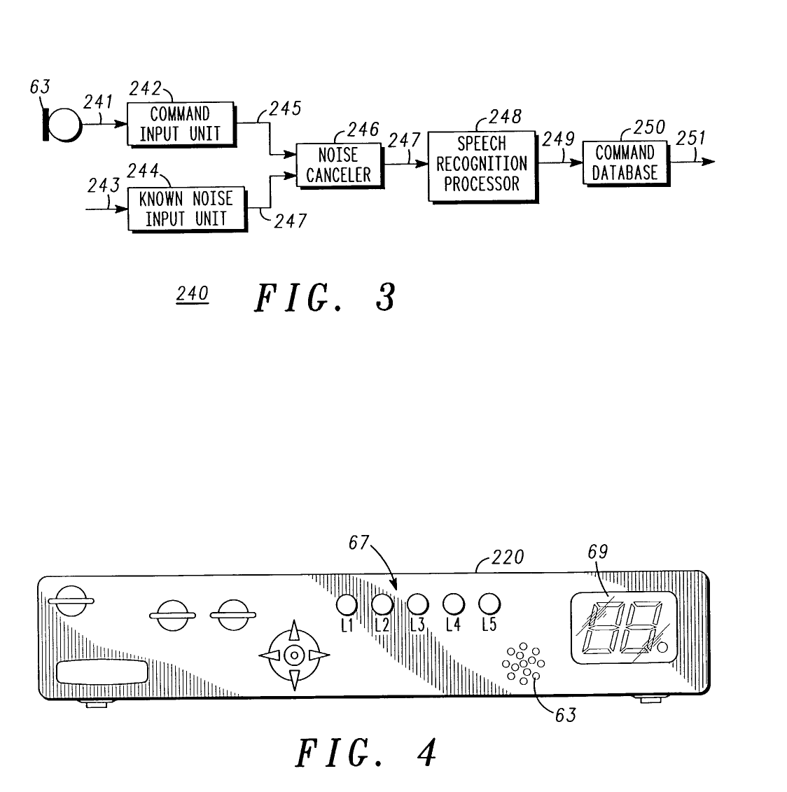

The voice command processing module 240 receives voice commands 60 from a user 62 and outputs a related control signal 64 to the microprocessor 220 as will be described in further detail hereinafter. The voice command processing module 240 will be described in greater detail hereinafter with reference to FIG. 3.

Still referring to FIG. 2, generally the CG 200 is the interface between the outside entities 14 the electronic devices 66 and the user 62. Information (data, voice, video, etc.) generally flows between the outside entities 14 over the communication links 24, 26, 28 to the CG 200 via the microphone 63. Information also flows between CG 200 and a frontal display 61 and between the CG 200 and the electronic devices 66 over the communication link 50. The user 62 outputs voice commands to the CG 200 and receives feedback from either the CG 200 or the electronic devices 66. It should be understood by those of skill in the art that the functional block diagram shown in FIG. 2 has been greatly simplified for purposes of explanation.

Referring to FIG. 3, the voice command processing module 240 is shown in greater detail. The voice command processing module 240 includes a command input unit 242, a known noise input unit 244, a noise canceller 246, a speech recognition processor 248 and a command database 250, (hereinafter, the “composite input”). The command input unit 242 receives an output from the a microphone 63 which receives an audible composite from the surrounding environment. This audible composite not only includes the voice command 60 from the user 62, but it also includes all other “noise” from the environment in which the user 62 is located. For example, if the user 62 is situated in the family room of a home, other environmental noises will include the voices from other people within the room and the output from all of the electronic devices 66.

The command input unit 242 performs preliminary filtering of the composite input 241 and provides a first input 245 to the noise canceller 246. The preliminary filtering may comprise any one of a number of noise filtering techniques which enhance the quality of the signal output. In an alternative embodiment, the command input unit 42 may be eliminated and the output 241 from the microphone 63 may be input directly into the noise canceller 246.

The known noise input unit 244 processes all of the “known” noises 243 from the electronic devices 66. For example, if the user 62 is watching the television 30, the “known” noise 243 will comprise the audio signal that is transmitted on the channel to which the television 30 is tuned. Likewise, any of the other audio outputs from any of the electronic devices 66 will comprise “known” noise sources which will provide known noise 243 to the known noise input unit 244. Preferably, the known noise 243 is detected by the known noise input unit 244 prior to being output from a speaker of an electronic device 66. For example, in the case of a CATV signal, the microprocessor 220 forwards a copy of the CATV program, including the audio portion, to the television 30 and a copy of the audio portion to the known noise input unit 244. This will facilitate a “clean” noise signal. Alternatively, each electronic device 66 may be equipped with a microphone at the output of the electronic device 66 which detects the known noise 243 and forwards the known noise 243 to the known noise input unit 244 via the communication. The output from the known noise input unit 244 provides a second input to 247 to the noise canceller 246.

The noise canceller 246 receives the two input signals 245, 247 and processes the signals such that all of the known noise signals are subtracted, from the composite noise signal thereby resulting in an output signal 247. Since the first input 245 is derived from a composite of all the audible signals in the environment and the second input 247 is derived from all of the known noises in the environment, the noise canceller 246 subtracts all of the known noises from the composite signal, thereby resulting in an output signal 247 which comprises only “unknown” audible signals. Since most of the noise in an entertainment environment is known, the noise canceller output signal 247 will primarily comprise the voice command 60 from the user 62 plus other unknown noises, such as background noise and noise from other people in the room. These other noises are generally minimal.

This output signal 247 may be further processed and filtered in accordance with known speech processing techniques, to further isolate the voice command 60. The noise canceller output signal 247 is input into the speech recognition processor 248 which processes the signal 247 to detect specific words. Speech recognition technology is well known to those skilled in the art, and the specific type of speech recognition technology employed by the speech recognition processor 248 is not central to the present invention. The speech recognition processor 248 outputs an output voice signal 249 which comprises one or more “identified” words in an ASCII or other type of format.

The output voice signal 249 is input into the command database 250, which compares the output voice signal 249 with a previously stored signal within the command database 250. When a match is found between the output voice signal 249 and a signal stored within the command database 250, the command database 250 outputs a control signal 251. This control signal 251 is forwarded to the microprocessor 220 shown in FIG. 2. The microprocessor 220 then uses either the internal communication link 50 or an RF or IF output (not shown) to control the destined electronic device 66. Control of such an electronic device 66 is well known to those of skill in the art and will not be further explained hereinafter. The voice command processing module 240 presents significant advantages over prior systems and methods for controlling information appliances.

Referring to FIG. 4, the front face of the CG 220 is shown. This embodiment of the communication gateway 220 includes the microphone 63 for receiving audible inputs such as the voice commands 60 from the user 62 and the other environment noises. Also included is a plurality of LEDs 67 and an alpha-numeric display 69. The LEDs 67 and the alpha-numeric display 69 provide feedback to the user 62 such that the user 62 can determine the state of the CG 220. Other feedback to the user 62 may be received through any of the information appliances 66 such as a visual feedback from the television 30 or an audible feedback from the stereo 32.

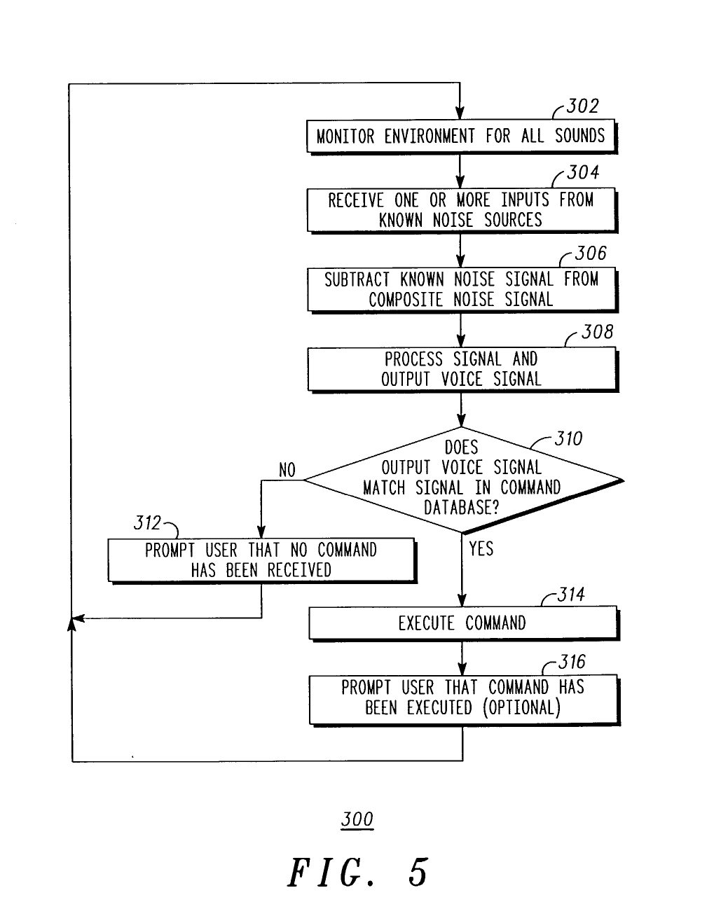

Referring to FIG. 5, a noise cancellation method 300 in accordance with the present invention is shown. The method 300 begins with the command input unit 242 monitoring the environment for all audible sounds, and generating a composite noise signal, (step 302). The command input unit 242 may optionally preprocess the received signal for enhancement. Simultaneously, the known noise input unit 244 receives one or more inputs and generates a known noise signal, (step 304). The known noise signal is then subtracted from the composite noise signal (step 306) in the noise canceller 246 and the resulting signal is processed by the speech recognition processor 248 to output a speech output 249 (step 308). The output voice signal 249 is compared to the signals stored in the command database 250 (step 310) to determine whether the output voice signal 249 matches any of the stored commands. If so, the command is executed (step 314). The CG 200 may also prompt the user that the command has been executed (step 316). Step 316 may be performed whether or not the execution of the command is obvious to the user 62. If the output voice signal 249 does not match any signal in the command database as determined by step 310, the user is prompted that no command has been received (step 312). In order to eliminate unwanted and/or unnecessary prompts each time a sound is made in the environment, the prompt at step 312 may comprise illuminating one or more of the LEDs 67 on the face of the CG 220. Additionally, it should be understood that the prompt referred to in steps 312 and 316 may be audible, visual and/or a combination of both audible and visual prompts, either directly from the CG 200 or via one of the electronic devices 66.

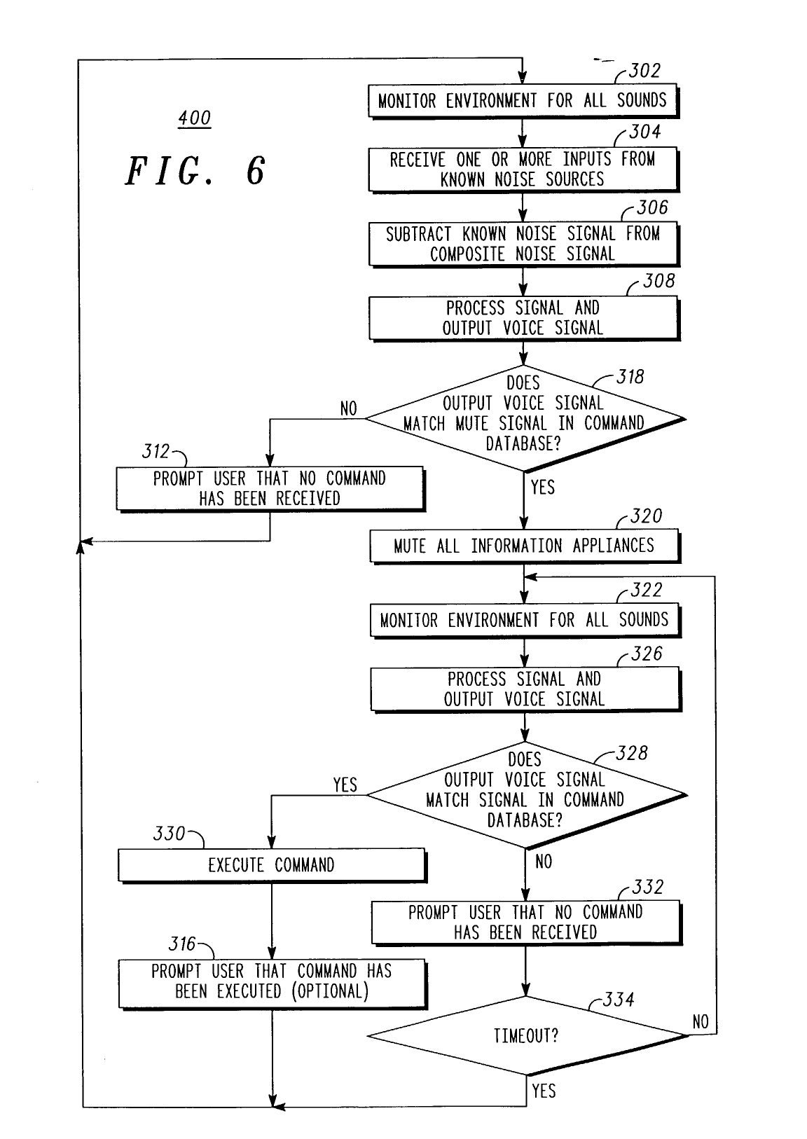

In an alternative embodiment of the present invention, the method 300 as shown in FIG. 5 may be modified to the method 400 as shown in FIG. 6. The identical steps of the methods 300, 400 are numbered in a like matter and will not be further explained with reference to FIG. 6. Using this alternative method 400, the user first supplies a “muting word” which mutes all electronic devices 66 such that further voice commands can processed with a minimum of environmental noise. In this method 400, steps 302-308 perform the same signal processing. However, step 318 determines only whether the voice output signal matches the “muting word” command signal in the command database (step 318) by searching for a single predetermined command, (i.e. the muting word), thereby greatly simplifying the signal processing requirements. Preferably, the command may be selected by the user or may be preset, such that it is not a spoken word that is likely to occur often in everyday conversation. For example, the user may invoke a name such as “Bartholomew” to mute all devices and begin the voice command procedure. This command may also be changed as desired by the user for a different language or simply for the user's preference to personalize the command.

Once it has been determined that the output voice signal matches the muting word in the command database (step 318), all electronic devices 66 are muted 320 and the system monitors the environment for all audible sounds (step 322). The signal is then is processed by the speech recognition processor (step 326). In this portion of the procedure 400, since there are no known noise sources present, these sources do not have to be monitored and a subtraction step similar to step 306 is not performed. The output voice signal 249 is compared to those stored in the command database 250 for any matches (step 328). If a match is found, the command is executed (step 330) and the user is prompted (step 316). The prompt in this embodiment may be the release of the muting of all the electronic devices 66 that was applied in step 320. In this manner, the user will know that the command has been executed. If no matches in step 328 are found, the user is prompted that no command has been received (step 332). A “timeout” feature 334 is also included whereby if no valid command has been detected within a certain time period, (such as 10 seconds), the system will revert to step 302.

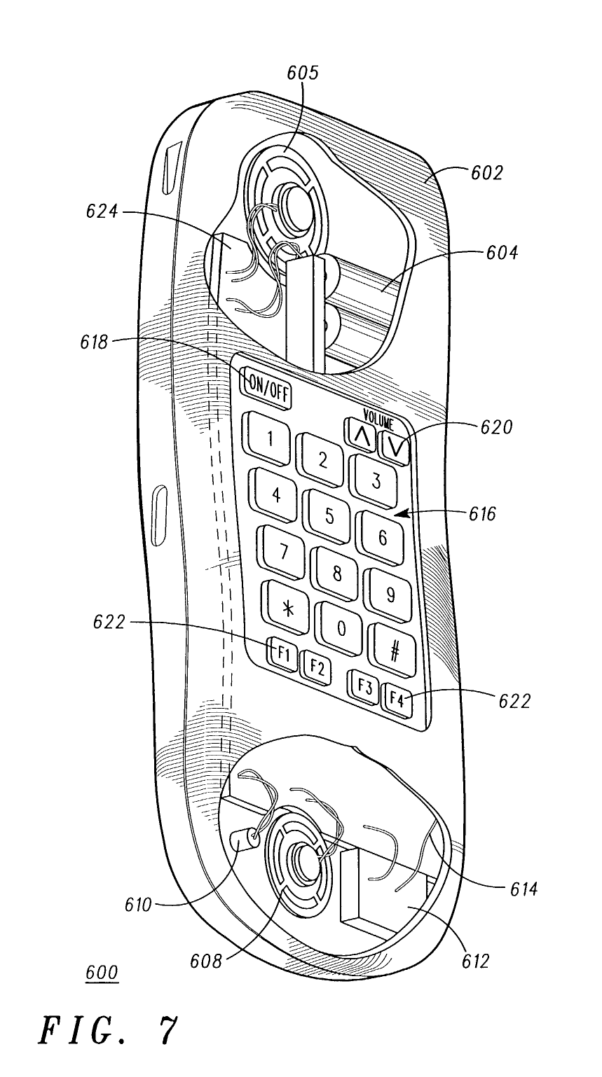

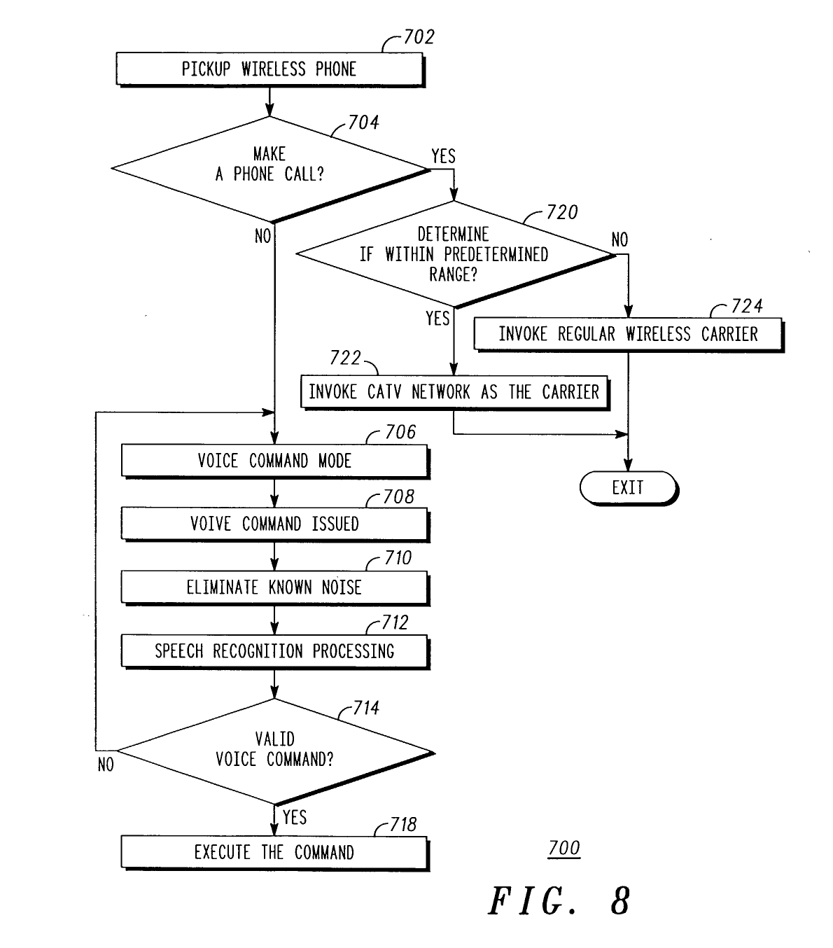

An alternative embodiment of the present invention will be explained with reference to FIG. 7. In this embodiment, the system is coupled with a wireless phone to achieve enhanced reliability and user convenience. As with most wireless phones, the wireless phone 600 of the present invention comprises a handset 602, one or more batteries 604, a speaker 605, a microphone 608, a visual indicating device 610 (such as an LED) and a transceiver 612 with an antenna 614. The wireless phone 600 also includes a keypad 616 including standard telephone dialing digit keys, an ON/OFF switch 618 and optional volume keys 620 or a plurality of function keys F1-F4 622. A processor 624 oversees and controls all of the functions of the wireless phone 600. All of the components on the wireless phone 600, as shown in FIG. 7, operate in a standard manner as current wireless phones. However, in accordance with the present invention, enhanced functionality is provided as will be described in detail hereinafter.

In this embodiment, the microphone 608 replaces the microphone 63 located on the CG 220. This has the advantage of having the microphone 608 immediately adjacent to the mouth of the user 62 such that a substantial amount of background noise is reduced. Accordingly, the function of the command input unit 242 as shown in FIG. 3 is performed by the microprocessor 624. The output signal 245 from the command input unit 242 is then forwarded to the transceiver 612 and transmitted via the antenna 614 via a wireless link to the CG 200. The wireless link is preferably RF, but may be IR or a combination thereof.

In this embodiment, the same functionality as shown in FIG. 3 is provided, except that the processing is split between the wireless phone 600 and the voice command processing module 240. The methods 300,400 as shown in FIGS. 5 and 6 will operate in the same manner as hereinbefore described.

It should also be understood by those of skill in the art that the functionality of the system is paramount, not the specific hardware. Nor it is important which hardware components perform which processing steps. For example, the noise subtraction step 306 which was described with reference to FIGS. 5 and 6, may be performed solely within the wireless phone 600, whereby the known noise input unit 244 resides within the CG 200 and the output 247 from the known noise input unit 244 is wirelessly transmitted (via RF or IR) from the CG 200 to the wireless phone 600. Likewise, network resources upstream of the CG 200, such as the CATV headend 18, may assist or bear the processing burden for speech recognition or other processing functions. These network resources are network computers, automated or intelligent applications or even human assistance.

In support of further functionality, the wireless phone 600 may provide “dual mode” functionality. With such functionality, the wireless phone 600 will process all telephone signals with the CG 200 such that any of the CATV headend 18, the PSTN 20 or the wireless network 22 may be the preferred carrier. The CG 200 will act as the base station for the wireless phone 600 when the wireless phone 600 is within a predetermined range. Once the wireless phone 600 exceeds the predetermined range, it will communicate directly with base stations on a wireless carrier's network.

A procedure using a wireless phone 600 in accordance with this embodiment of the present invention is shown in FIG. 8. In this method 700, the wireless phone is accessed (step 702) and the user determines whether or not they wish to make a call (step 704). This determination may be a voice command or may be invoked by pressing one of the function keys. In any event, if the user desires to invoke a functionality of the system which is not a telephone call, the voice command mode (step 706) is activated. This voice command is processed in accordance with one of the procedures 300,400 described hereinbefore which generally include issuing a voice command by the user (step 708), detecting the audible inputs and eliminating the known noise from the composite signal (step 710) and performing speech recognition processing (step 712). If it has been determined that a valid voice command has been received, (step 714) the command is executed (step 718). If a valid voice command has not been received, the process is repeated.

If it has been determined (step 704) that the user desires to make a phone call, the system determines if the wireless phone 600 is within the predetermined range (step 720). If so, the CATV network is selected as the carrier for that telephone call (step 722). The telephone conversation will then be processed via the CATV headend 18. Of course, if the user so desires, either the PSTN 20 or the wireless network 22 may be used to process such a call.

If it has been determined that the wireless phone 600 is outside of the predetermined range (step 720), the regular wireless carrier is invoked (step 724) to support the telephone conversation.

The user may choose from among different telephone service providers depending on service reliability, service rates or other factors. The selection may be performed by the user on a real-time basis or may be preset by the user to invoke one carrier or another depending upon the day of the week, time of day or other factors.

While the present invention has been described in terms of the preferred embodiment, other variations which are within the scope of the invention as outlined in the claims below will be apparent to those skilled in the art.

What is claimed is:

1. A voice-controlled communication gateway for facilitating communications between at least one outside entity and at least one electronic device, the electronic device outputting a known signal corresponding to the audible output from the electronic device, the communication gateway comprising:
a receiver for receiving communications from the outside entities;
a first transmitter for transmitting communications to the outside entities;
a microphone for receiving all of the audible signals within an environment, and for outputting a composite signal;
a voice module for receiving said composite signal and said known signal and for generating a command; and
a microprocessor, coupled to said receiver, transmitter and voice module for receiving and executing said command.

2. The communication gateway of claim 1 whereby the voice module further comprises a noise canceller for subtracting said known signal from said composite signal to generate an unknown noise signal.

3. The communication gateway of claim 2 further comprising a speech recognition processor for accepting said unknown noise signal and for outputting a voice signal output comprising one or more identified words.

4. The communication gateway of claim 3 further comprising a command database which accepts said one or more identified words and compares said identified words to commands stored in memory to output said command.

5. The communication gateway of claim 1 further comprising:
a remote unit having a second transmitter;
a second receiver, located on said communication gateway, for receiving signals from said second transmitter; and whereby said microphone is located in said remote unit.

6. The communication gateway of claim 5 whereby said remote unit further includes a telephone, whereby said second transmitter transmits telephone signals from the remote unit to said second receiver.

7. The communication gateway of claim 6, whereby said remote unit further includes a processor for processing, at least in part, said composite signal.

8. The communication gateway of claim 7, wherein the processed composite signal is transmitted from said second transmitter to said second receiver for further processing by said microprocessor.

9. A voice-controlled communication gateway for controlling a plurality of electronic devices, each electronic device outputting a known signal corresponding to the audible output from the electronic device, the communication gateway comprising:
a microphone for receiving all of the audible signals within an environment, and for outputting a composite signal;
a voice module for subtracting each of said known signals from said composite signal to output an unknown signal; and
microprocessor, for receiving said unknown noise signal, processing said unknown noise signal, processing said unknown noise signal to determine whether it comprises a command and, if so, executing said command to control at least one of said electronic devises.

10. The communication gateway of claim 9 further comprising a speech recognition processor for processing said unknown noise signal and for outputting a voice signal output comprising one or more identified words.

11. The communication gateway of claim 10 further comprising a command database which accepts said one or more identified words and compares said identified words to commands stored in said command database to output said command.

12. The communication gateway of claim 9 further comprising:
a remote unit having a second transmitter;
a second receiver, located on said communication gateway, for receiving signals from said second transmitter; and
whereby said microphone is located in said remote unit.

13. The communication gateway of claim 12 whereby said remote unit further includes a telephone, whereby said transmitter transmits telephone signals from the remote unit to said second receiver.

14. A voice-controlled communication gateway for controlling at least one electronic device, the electronic device outputting an audible output; the communication gateway comprising:
a memory, for storing at least one executable command with an associated voice signal;
a microphone for receiving all of the audible signals within an environment, and for outputting a composite signal; and
microprocessor, for subtracting said audible output from said composite signal to output an unknown noise signal, and for comparing said unknown noise signal with said stored voice signal; whereby if said comparison is favorable, the executable command associated with said voice signal is executed.
